(19) United States
(12) Patent Application Publication
(10) Pub. No.: US 2012/0054065 A1
(43) Pub. Date: Mar. 1, 2012

(54) SYSTEM AND METHOD FOR SERVICE RECOMMENDATION

(75) Inventors: Jung Sik SUNG, Daejeon (KR); Jong Moo SOHN, Daejeon (KR); Jae Doo HUH, Daejeon (KR); Young Sik CHUNG, Daejeon (KR); Eui Hyun PAIK, Daejeon (KR)

(73) Assignee: Electronics and Telecommunications Research Institute, Daejeon (KR)

(21) Appl. No.: 13/214,339

(22) Filed: Aug. 22, 2011

(30) Foreign Application Priority Data
Aug. 24, 2010 (KR) 10-2010-0082073

(51) Int. Cl. G06Q 30/00

(52) U.S. Cl. 705/26.7

(57) ABSTRACT

Provided are a system and a method for service recommendation. A service recommendation system according to an exemplary embodiment of the present invention includes: a service recommendation unit that, when a user connects from a user terminal, searches a user recommendation service list and a terminal adaptive execution engine list, both of which are generated in advance regarding the user terminal, and provides the user with a recommendation service list, where each service is listed in the searched user recommendation service list and uses an excution engine listed in the terminal adaptive execution engine list; and a user recommendation list generation unit that extracts preferred services and recently used services using service history and statistics information stored regarding the user, and generates the user recommendation service list regarding the user by listing the extracted services and services similar thereto.

### CROSS-REFERENCE TO RELATED APPLICATIONS

This application claims priority under 35 U.S.C. §119 to Korean Patent Application No. 10-2010-0082073, filed on Aug. 24, 2010, in the Korean Intellectual Property Office, the disclosure of which is incorporated herein by reference in its entirety.

### TECHNICAL FIELD

Following disclosure relates to a service recommendation method, and more particularly, to a system and a method for service recommendation which can recommend a service considering a user preference characteristic.

### BACKGROUND

Recently, a mobile communication terminal provides diversified services such as contact list, SMS (short message service), wireless Internet, a real-time message, etc., in addition to a telephone call service. Each service provides contents of diversified categories such as ringtones, a background screen, music, movie, real-time information, and the like.

Then, it is inconvenient to select a desired content among diversified contents provided from a content providing system through the mobile communication terminal since menu accessing and content selection should be repetitively performed. Communication fees are charged in the case of wireless Internet.

In related art content providing system, there is a system that recommends contents suitable for a user using personal information, context information, communication network information of a user terminal, and the like. However, since the related art system considers only user characteristics without considering the characteristic of the user terminal, the user selects content directories or application program directories including contents or application programs which are presently usable in the user terminal and downloads the contents or application programs in the selected directory. Therefore, the above-described problem is not yet solved.

In another related art content providing system, there is a system that recommends user-customized contents using preference information previously defined by the user, user information (including a use history, a use time, a user pattern, and the like) by learning, and communication network presence information (including positional information, time, local information, weather information, and the like). However, since the related art system recommends the user-customized contents regardless of the user terminal used by the user, it is not suitable to apply to an application store accommodating a plurality of user terminals having diversified characteristics or an open-type service.

### SUMMARY

An exemplary embodiment of the present invention provides a service recommendation system that includes: a service recommendation unit that, when a user connects from a user terminal, searches a user recommendation service list and a terminal adaptive execution engine list, both of which are generated in advance regarding the user terminal, and provides the user with a recommendation service list, where each service is listed in the searched user recommendation service list and uses an excution engine listed in the terminal adaptive execution engine list; and a user recommendation list generation unit that extracts preferred services and recently used services using service history and statistics information stored regarding the user, and generates the user recommendation service list regarding the user by listing the extracted services and services similar thereto.

Another exemplary embodiment of the present invention provides a service recommendation method that includes: generating and storing a user recommendation service list regarding accessed user; generating and storing a terminal adaptive execution engine list regarding accessed user terminal; retrieving the user recommendation service list regarding the user and the terminal adaptive execution engine list regarding the user terminal from the stored user recommendation service list and terminal adaptive execution engine list when the user accesses using the user terminal; extracting a recommendation service list using the searched terminal adaptive execution engine list from the searched user recommendation service list; and providing the extracted recommendation service list to the user terminal.

Yet another exemplary embodiment of the present invention provides a service recommendation method that includes: storing terminal profile of accessed user terminal; storing execution engine profile and service profile of provided service; extracting the execution engine profile matching the terminal profile of the user terminal from the previously stored execution engine profile; checking if the previously stored service profile matches a execution engine corresponding to the extracted execution engine profile to determine whether contents or semantic conversion is required at the time of executing the execution engine in the user terminal; and determining the execution engine corresponding to the matched service profile on the basis of the check result to be listed in a terminal adaptive execution engine list regarding the user terminal.

Other features and aspects will be apparent from the following detailed description, the drawings, and the claims.

### BRIEF DESCRIPTION OF THE DRAWINGS

FIG. 1 is a configuration diagram showing a service recommendation system according to an exemplary embodiment of the present invention;

FIGS. 2A and 2B are a flowchart showing a service recommendation method according to an exemplary embodiment of the present invention;

FIG. 3 is a flowchart showing a user recommendation service list generation method according to an exemplary embodiment of the present invention; and

FIG. 4 is a flowchart showing a terminal adaptive execution engine list generation method according to an exemplary embodiment of the present invention.

FIG. 5 is a flowchart showing a service recommendation method according to an exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, exemplary embodiments of the present invention will be described in detail with reference to the accompanying drawings.

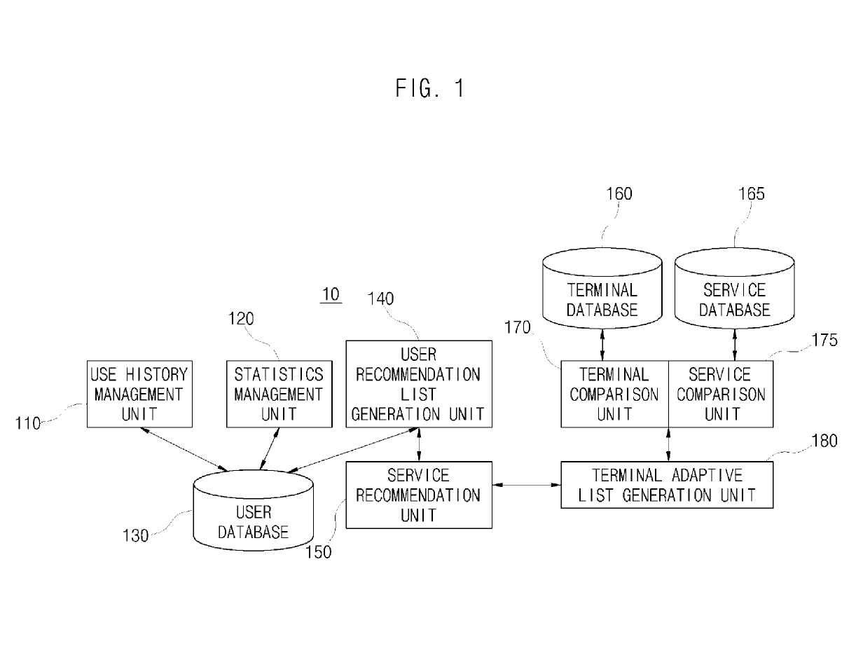

FIG. 1 is a configuration diagram showing a service recommendation system according to an exemplary embodiment of the present invention.

As shown in FIG. 1, the service recommendation system 10 according to the exemplary embodiment of the present invention includes a use history management unit 110, a statistics management unit 120, a user recommendation list generation unit 140, a user database 130, a terminal database 160, a service database 165, a terminal comparison unit 170, a service comparison unit 175, a terminal adaptive list generation unit 180, and a service recommendation unit 150.

When a user accesses to use a service, the user history management unit 110 generates service history information regarding the used service and stores it in the user database 130.

The statistics management unit 120 generates service statistics information on a recently searched category and a recently searched keyword and stores it in the user database 130 when the user searches a category for the services or searches services with keywords.

The user recommendation list generation unit 140 extracts frequently used services and recently used services using the service history information or statistics information previously stored in the user database 130 regarding the user, and generates a user recommendation service list by listing the extracted services and services similar thereto and stores it the user database 130.

The user database 130 stores the service history information, the service statistics information, the user recommendation service list, and the like.

The terminal database 160 stores a terminal profile representing characteristics of a user terminal, and the like.

The service database 165 stores execution engines of the previously stored services, execution engine profiles, services, service profiles, terminal adaptive execution engine lists, and the like.

When a new terminal accesses the system 10, the terminal comparison unit 170 reads the execution engine profile information stored in the service data base 165 and reads information on a new terminal stored in the terminal database 160, and thereafter, compares two profiles with each other to extract a matched execution engine profile.

The service comparison unit 175 checks whether the extracted execution engine profile matches each previously stored service profiles in the service database 165 to check whether contents conversion or semantic conversion is required at the time of executing the extracted execution engine in the user terminal.

The terminal adaptive list generation unit 180 generates a terminal adaptive execution engine list from the extracted execution engine profile and stores it in the service database 165. At this point, if the contents conversion or the semantic conversion is required, the terminal adaptive list generation unit 180 generates a terminal adaptive execution engine list with additional conversion information required for the conversion.

When the user connects from the user terminal, the service recommendation unit 150 searches a user recommendation service list generated in advance with respect to the corresponding user and a terminal adaptive execution engine list generated in advance regarding the corresponding user terminal from the service database 165. And the service recommendation unit 150 provides the user with a recommendation list of services, where each service is listed in the searched user recommendation service list and uses an excution engine listed in the terminal adaptive execution engine list.

The service recommendation unit 150 may determine the recommendation service list and provide it to the user terminal referring to user's preference information or a terminal profile of the user terminal when the user recommendation service list does not exist in the user database 130.

In FIG. 1, the user database 130, the terminal database 160, and the service database 165 may be configured as one device.

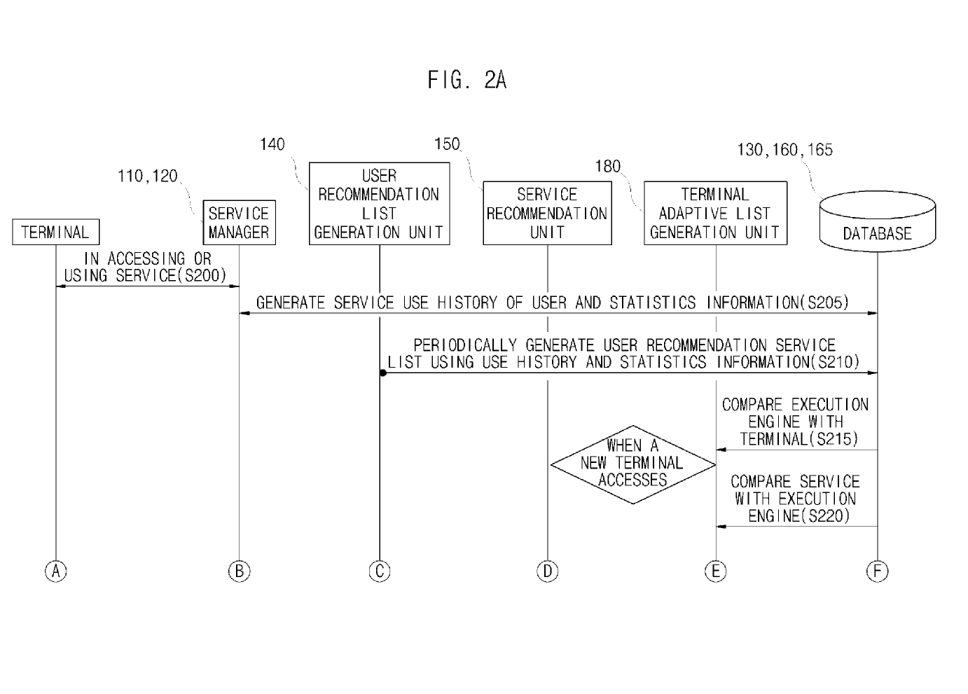

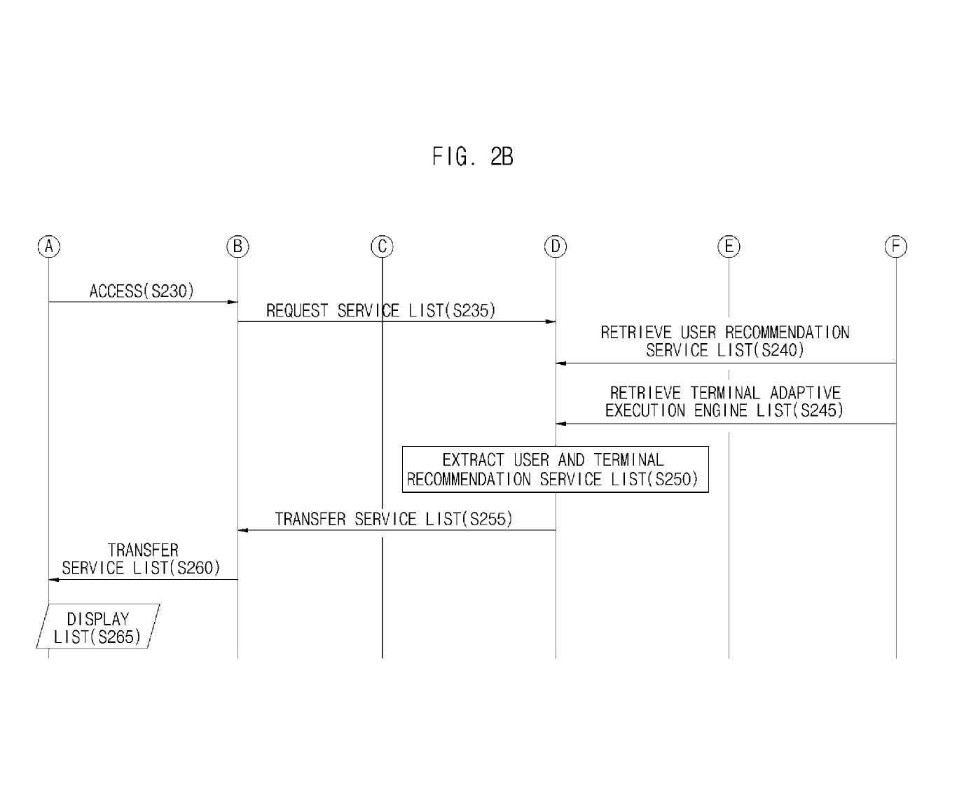

Hereinafter, referring to FIGS. 2A and 2B, the service recommendation method according to the exemplary embodiment of the present invention will be described. FIGS. 2A and 2B are a flowchart showing a service recommendation method according to an exemplary embodiment of the present invention.

Referring to FIGS. 2A and 2B, when a user accesses to search or use a service (S200), a service manager (the use history management unit and the statistics management unit of FIG. 1) generates service history information and statistics information of the user which accesses, and extracts characteristics information of a user terminal which accesses and stores it in databases 130, 160, and 165 (S205).

Further, a user recommendation list generation unit 140 periodically generates a user recommendation service list using the service history information and the service statics information and stores it in the databases 130, 160, and 165 as described above (S210).

When a new user terminal accesses, a terminal comparison unit 170 searches whether an execution engine profile matching a terminal profile exists among execution engine profiles previously stored in the databases 130, 160, and 165 (S215).

The service comparison unit 175 checks whether contents/semantic conversion is required at the time of executing the searched execution engine in the user terminal by comparing each of the stored service profiles in the databases 130, 160, and 165 with the searched execution engine profiles (S220).

If the contents conversion or the semantic conversion is required, a terminal adaptive list generation unit 180 generates a terminal adaptive execution engine list for the accessed user terminal adding conversion information for required contents/semantic conversion to the searched execution engine and stores it in the databases 130, 160, and 165 (S225). If the contents or semantic conversion is not required, the terminal adaptive list generation unit 180 generates the terminal adaptive execution engine list using the retrieved execution engine.

When the user connects from the user terminal (S230), service managers 110, 120, and 140 request a service list to a service recommendation unit 150 (S235).

The service recommendation unit 150 searches the user recommendation service list (S240) and the terminal adaptive execution engine list (S245) from the databases 130, 160, and 165, and arranges only services commonly included in both lists to be listed in the recommendation service list (S250).

Subsequently, the service recommendation unit 150 transfers the recommendation service list to the service managers 110, 120, and 140 (S255) and the service managers 110, 120, and 140 provide the transferred recommendation service list to the user terminal (S260).

Thereafter, the user terminal displays the recommendation service list (S265) and the user uses desired contents, services, or application programs using the displayed recommendation service list.

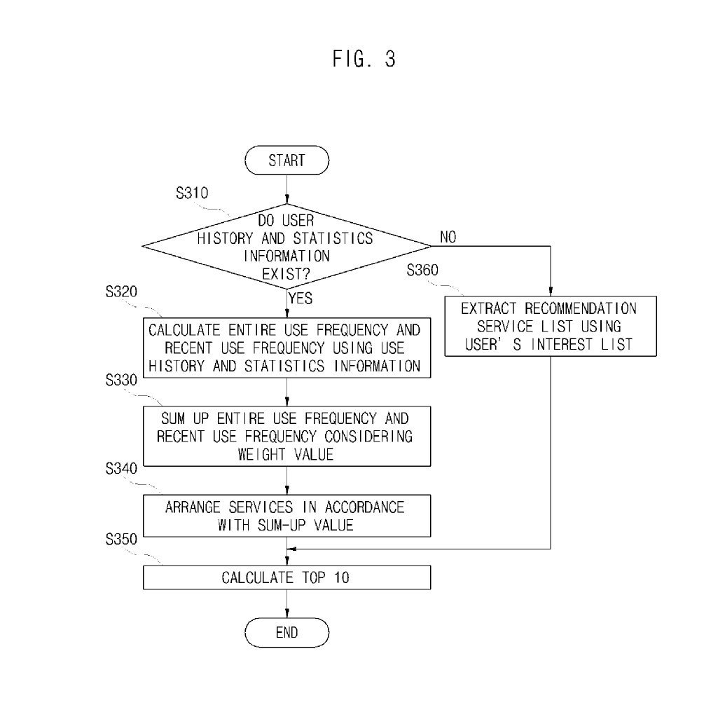

Hereinafter, referring to FIG. 3, a user recommendation service list generation method according to an exemplary embodiment of the present invention will be described. FIG. 3 is a flowchart showing a user recommendation service list generation method according to an exemplary embodiment of the present invention.

Referring to FIG. 3, when a new user accesses to use a service, a service recommendation system 10 searches whether history information of the user or service statistics information exists (S310).

When the history information or service statics information exists on the basis of the retrieval result, the service recommendation system 10 calculates the entire use frequency and the recent use frequency (recency) of the user for services corresponding to the service history information and the service statistics information of the user (S320).

In addition, the service recommendation system 10 calculates an integral value of the entire use frequency and the recent user frequency calculated by considering a weighted value of the service statistics information (S330).

The service recommendation system 10 arranges the services corresponding to the service history information and the service statistics information in accordance with the integral value (S340), and extracts ten upper services among them to be listed in a user recommendation service list (S350).

Meanwhile, if the service history information or statistics information does not exist on the basis of the retrieval result at step S310, the service recommendation system 10 extracts the recommendation service list using an interest list which a user additionally registers (S360).

Meanwhile, in FIG. 3, the number of recommendation service list is limited to 10, but is not limited thereto.

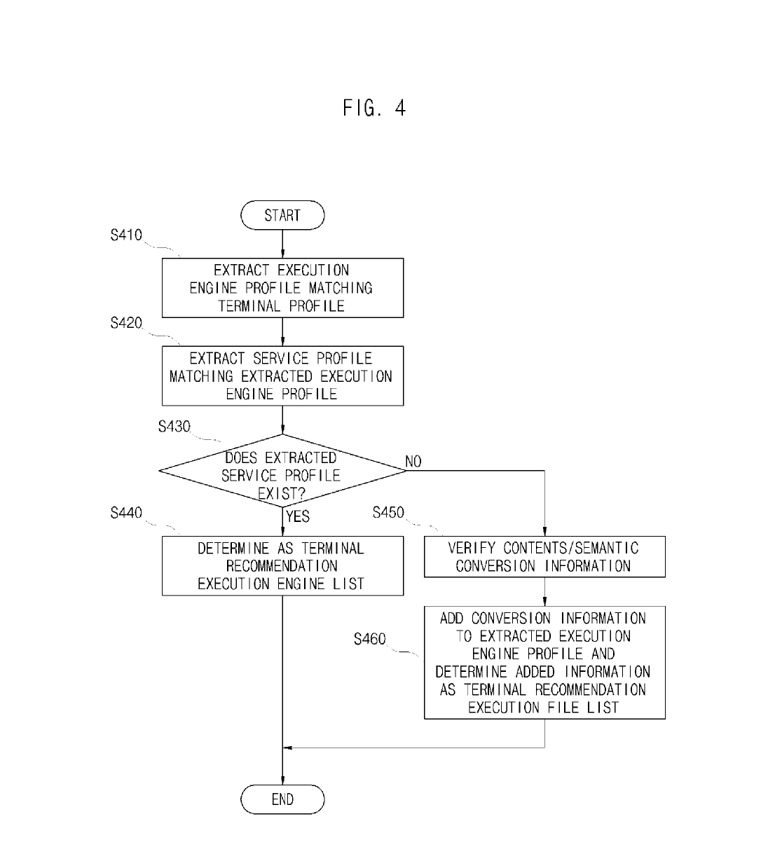

Hereinafter, referring to FIG. 4, a terminal adaptive execution engine list generation method according to an exemplary embodiment of the present invention will be described. FIG. 4 is a flowchart showing a terminal adaptive execution engine list generation method according to an exemplary embodiment of the present invention.

Referring to FIG. 4, when a new user terminal accesses, a service recommendation system 10 extracts an execution engine profile matching a terminal profile of the user terminal which accesses among execution engine profiles previously stored in databases 130, 160, and 165 (S410).

In this case, it is assumed that a terminal profile, a service profile, a service execution engine profile, and the like are previously stored in the databases 130, 160, and 165.

The service recommendation system 10 extracts the service profile matching the extracted execution engine profile among the previously stored service profiles (S420).

The service recommendation system 10 checks whether the extracted service profile exists (S430). And if the extracted service profile exists, the service recommendation system 10 generates a user terminal adaptive execution engine list using a service key of a service, a device ID, and an execution engine key corresponding to the extracted service profile (S440). That is, the service recommendation system 10 determines that the service corresponding to the service profile can be executed in the user terminal without contents/semantic conversion and generates the user terminal adaptive execution engine list using the extracted execution engine profile.

On the contrary, the service recommendation system 10 determines that the contents/semantic conversion is required at the time of the extracted execution engine in the service user terminal if the extracted service profile does not exist on the basis of the check result at step S430 and checks the required conversion information (S450).

Subsequently, the service recommendation system 10 generates the terminal adaptive execution engine list with the checked conversion information (S460).

Thereafter, the service recommendation system 10 may store the terminal adaptive execution engine list generated through the above-mentioned process in databases 130, 160, and 165 and provide, for example, upper ten of execution engine list to the user terminal.

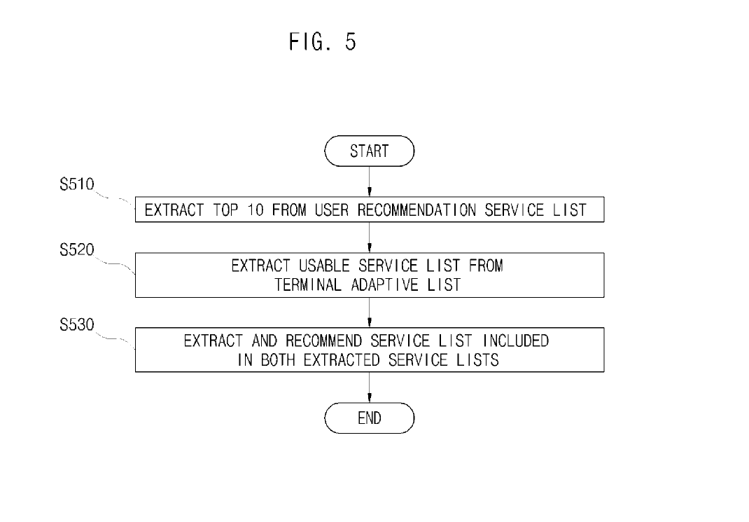

Hereinafter, referring to FIG. 5, a service recommendation method according to an exemplary embodiment of the present invention will be described. FIG. 5 is a flowchart showing a service recommendation method according to an exemplary embodiment of the present invention.

Referring to FIG. 5, the service recommendation system 10 extracts, for example, ten upper services from a user recommendation service list from databases 130, 160, and 165 (S510).

Subsequently, the service recommendation system 10 extracts a terminal adaptive execution engine list from the databases 130, 160, and 165 (S520).

In addition, the service recommendation system 10 provides a service list using the user terminal adaptive execution engine among ten upper extracted services to the user terminal (S530).

As such, according to exemplary embodiments of the present invention, since it is possible to provide user and terminal adaptive service recommendation services by considering user preference information and characteristics of a terminal, it is possible to support to reduce a user's repeated work for service selection and a burden of communication charges.

Moreover, since the present invention recommends a service, and the like by considering the characteristics of the terminal, a service or an application program may not be managed for each terminal characteristics, particularly, the present invention can provide a convenience in implementing, particularly, a service framework accommodating diversified user terminal platforms or an open-type app store.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A service recommendation system, comprising:
a service recommendation unit that, when a user connects from a user terminal, searches a user recommendation service list and a terminal adaptive execution engine list, both of which are generated in advance regarding the user terminal, and provides the user with a recommendation service list, where each service is listed in the searched user recommendation service list and uses an excution engine listed in the terminal adaptive execution engine list; and
a user recommendation list generation unit that extracts preferred services and recently used services using service history and statistics information stored regarding the user, and generates the user recommendation service list regarding the user by listing the extracted services and services similar thereto.

2. The system of claim 1, further comprising:
a history management unit that generates the service history information regarding a service when the user accesses to use the service;
a statistics management unit that generates the service statistics information regarding a recently searched category and a keyword as the user searches a category for the services or searches the services with keywords; and
a user database that stores the service history information, the service statistics information, and the user recommendation service list.

3. The system of claim 1, wherein the user recommendation list generation unit periodically generates the user recommendation service list.

4. The system of claim 1, further comprising:
a terminal database storing a terminal profile of a terminal that previously accessed including the user terminal;
a service database storing an execution engine of a provided service, an execution engine profile, a service, a service profile, and the terminal adaptive execution engine list; and
a terminal comparison unit that checks whether the stored terminal profile matches the stored execution engine profile to check an execution engine executable in the user terminal.

5. The system of claim 4, further comprising:
a service comparison unit that checks whether a contents conversion or a semantic conversion is required at the time of executing any service in the user recommendation service list in the user terminal by comparing service profiles in the user recommendation service list with the execution engine profile of the executable execution engine; and
a terminal adaptive list generation unit that generates the terminal adaptive execution engine list with an additional conversion information required for the conversion if the contents conversion or the semantic conversion is required.

6. The system of claim 1, wherein the service recommendation unit determines the recommendation service list referring to preference information of the user or terminal profile of the user terminal and provides the determined list to the user terminal if the user recommendation service list does not exist.

7. A service recommendation method, comprising:
generating and storing a user recommendation service list regarding accessed user;
generating and storing a terminal adaptive execution engine list regarding accessed user terminal;
retrieving the user recommendation service list regarding the user and the terminal adaptive execution engine list regarding the user terminal from the stored user recommendation service list and terminal adaptive execution engine list when the user connects from the user terminal;
extracting a recommendation service list using the searched terminal adaptive execution engine list from the searched user recommendation service list; and
providing the extracted recommendation service list to the user terminal.

8. The method of claim 7, wherein the generating and storing the user recommendation service list includes:
generating service history information regarding services used by the user;
generating service statistics information as the user searches a desired service using a category or a keyword for each service; and
storing the service history information and the service statistics information.

9. The method of claim 8, wherein the generating and storing the user recommendation service list further includes:
calculating entire use frequency and recent use frequency of the user for each service using the history information or the statistics information;
summing up the entire use frequency and the recent use frequency considering a weighted value included in the statistics information; and
arranging the services in accordance with the sum-up result and determining the arranged services as the user recommendation service list.

10. The method of claim 7, wherein the generating and storing the terminal adaptive execution engine list includes:
storing terminal profile of the user terminal; and
storing profiles of execution engines and service profiles of provided services.

11. The method of claim 10, wherein the generating and storing of the terminal adaptive execution engine list includes:
extracting a profile of an execution engine matching the profile of the user terminal among the previously stored profiles of the execution engines;
checking if each of the previously stored service profiles matches the profile of the extracted execution engine to determine whether or not contents or semantic conversion is required at the time of executing the extracted execution engine in the user terminal; and
determining the extracted execution engine corresponding to the matched service profile on the basis of the check result to be listed in the terminal adaptive execution engine list regarding the user terminal.

12. The method of claim 11, wherein the determining further includes adding an additional conversion information required for the conversion to the extracted execution engine and determining the execution engine with the conversion information to be listed in the terminal adaptive execution engine list if no service profile matches on the basis of the check result.

13. The method of claim 7, wherein at the retrieving, if the user recommendation service list does not exist, the recommendation service list is determined by referring to the preference information of the user or the terminal profile of the user terminal and provided to the user terminal.

14. A service recommendation method, comprising:
storing terminal profile of accessed user terminal;
storing execution engine profile and service profile of provided service;
extracting the execution engine profile matching the terminal profile of the user terminal from the previously stored execution engine profile;
checking if the previously stored service profile matches a execution engine corresponding to the extracted execution engine profile to determine whether contents or semantic conversion is required at the time of executing the execution engine in the user terminal; and
determining the execution engine corresponding to the matched service profile on the basis of the check result to be listed in a terminal adaptive execution engine list regarding the user terminal.

15. The method of claim 14, comprising:
retrieving whether the user recommendation service list regarding the user and the terminal adaptive execution engine list regarding the user terminal exist in the stored user recommendation service list and terminal adaptive execution engine list when the user connects from the user terminal;
extracting a recommendation service list using the searched terminal adaptive execution engine list from the searched user recommendation service list; and
providing the extracted recommendation service list to the user terminal.

16. The method of claim 14, further comprising:
adding conversion information required for the conversion to the extracted execution engine profile and determining the execution engine with the conversion information to be listed in the terminal adaptive execution engine list if no service profile matches on the basis of the check result.
